(19) United States
(12) Patent Application Publication
(10) Pub. No.: US 2013/0108925 A1
(43) Pub. Date: May 2, 2013

(54) ELECTRODE, FREE OF ADDED CONDUCTIVE AGENT, FOR A SECONDARY LITHIUM-ION BATTERY

(71) Applicant: Michael Holzapfel, Freising (DE)

(72) Inventor: Michael Holzapfel, Freising (DE)

(73) Assignee: SUED-CHEMIE IP GMBH & CO., KG, Munich (DE)

(21) Appl. No.: 13/575,710

(22) PCT Filed: Jan. 28, 2011
(86) PCT No.: PCT/EP2011/051192

§ 371 Date: Jan. 16, 2013

(30) Foreign Application Priority Data
Jan. 28, 2010 (DE) 10 2010 006 082.8

(51) Int. Cl. H01M 4/485; H01M 4/136; H01M 4/131

(52) U.S. Cl. CPC H01M 4/485; H01M 4/131; H01M 4/136
USPC 429/221; 429/231.1; 423/598; 252/520.21

(57) ABSTRACT

An electrode, free of added conductive agent, for a secondary lithium-ion battery with a lithium titanate as active material, and a secondary lithium-ion battery which contains the electrode.

### CROSS-REFERENCE TO RELATED APPLICATIONS

This application is a U.S. National Stage application claiming benefit of International Application No. PCT/EP2011/051192, filed Jan. 28, 2011, and claiming benefit of German Application No. DE 10 2010 006 082.8, filed Jan. 28, 2010. The entire disclosures of both PCT/EP2011/051192 and DE 10 2010 006 082.8 are incorporated herein by reference.

### BACKGROUND

The present invention relates to an electrode, free of conductive agent, with a lithium titanate as active material as well as to a secondary lithium-ion battery containing this.

The use of lithium titanate Li₄Ti₅O₁₂, or lithium titanium spinel for short, in particular as a substitute for graphite as anode material in rechargeable lithium-ion batteries has been proposed for some time.

A current overview of anode materials in such batteries can be found e.g. in: Bruce et al., Angew. Chem. Int. Ed. 2008, 47, 2930-2946.

The advantages of Li₄Ti₅O₁₂ compared with graphite are in particular its better cycle stability, its better thermal load capacity as well as the higher operational reliability. Li₄Ti₅O₁₂ has a relatively constant potential difference of 1.55 V compared with lithium and achieves several 1000 charge and discharge cycles with a loss of capacity of <20%.

Thus lithium titanate displays a clearly more positive potential than graphite, which has previously customarily been used as anode in rechargeable lithium-ion batteries.

However, the higher potential also results in a smaller voltage difference. Together with a reduced capacity of 175 mAh/g compared with 372 mAh/g (theoretical value) of graphite, this leads to a clearly lower energy density compared with lithium-ion batteries with graphite anodes.

However, Li₄Ti₅O₁₂ has a long life and is non-toxic and is therefore also not to be classified as posing a threat to the environment.

Various aspects of the production of lithium titanate Li₄Ti₅O₁₂ are described in detail. Usually, Li₄Ti₅O₁₂ is obtained by means of a solid-state reaction between a titanium compound, typically TiO₂, and a lithium compound, typically Li₂CO₃, at high temperatures of over 750° C., as described e.g. in U.S. Pat. No. 5,545,468 or in EP 1 057 783 A1.

Sol-gel methods, DE 103 19 464 A1, flame pyrolysis (Ernst, F. O. et al. Materials Chemistry and Physics 2007, 101(2-3, pp. 372-378), as well as so-called “hydrothermal methods” in anhydrous media (Kalbac, M. et al., Journal of Solid State Electrochemistry 2003, 8(1) pp. 2-6), but also in aqueous media (DE 10 2008 050 692.3), are also proposed. The thus-obtained lithium titanates can also be provided with a carbon-containing coating (EP 1 796 189 A2).

The particle-size distribution can also be set, depending on the production method. Meanwhile, almost all metal and transition metal cations are known from the state of the art as doping cations for doped lithium titanium spinels.

The material density of lithium titanium spinel is comparatively low (3.5 g/cm³) compared with e.g. lithium manganese spinel or lithium cobalt oxide (4 and 5 g/cm³ respectively), which are used as cathode materials.

However, lithium titanium spinel (containing Ti⁴⁺ exclusively) is an electronic insulator, which is why a conductive additive (conductive agent), such as e.g. acetylene black, carbon black, ketjen black, etc., always needs to be added to electrode compositions of the state of the art in order to guarantee the necessary electronic conductivity of the electrode. The energy density of batteries with lithium titanium spinel anodes thereby falls. However, it is also known that lithium titanium spinel in the reduced state (in its “charged” form, containing Ti³⁺ and Ti⁴⁺) becomes a virtually metallic conductor, whereby the electronic conductivity of the whole electrode would have to clearly increase.

In the field of cathode materials, doped or undoped LiFePO₄ has recently preferably been used as cathode material in lithium-ion batteries, with the result that e.g. a voltage difference of 2 V can be achieved in a combination of Li₄Ti₅O₁₂ and LiFePO₄.

The non-doped or doped mixed lithium transition metal phosphates with ordered or modified olivine structure or else NASICON structure, such as LiFePO₄, LiMnPO₄, LiCoPO₄, LiMnFePO₄, Li₃Fe₂(PO₄)₃ were first proposed as cathode material for secondary lithium-ion batteries by Goodenough et al. (U.S. Pat. No. 5,910,382, U.S. Pat. No. 6,514,640). These materials, in particular LiFePO₄, are also actually poorly to not at all conductive materials. Furthermore the corresponding vanadates have also been investigated.

An added conductive agent as already described in more detail above must therefore always be added to the doped or non-doped lithium transition metal phosphates or vanadates, as is the case with lithium titanate as well, before the latter can be processed to electrode formulations. Alternatively, lithium transition metal phosphate or vanadate as well as also lithium titanium spinel carbon composite materials are proposed which, however, because of their low carbon content, also always require the addition of a conductive agent.

Thus EP 1 193 784, EP 1 193 785 as well as EP 1 193 786 describe so-called carbon composite materials of LiFePO₄ and amorphous carbon which, when producing iron phosphate from iron sulphate, sodium hydrogen phosphate also serves as reductant for residual Fe³⁺ radicals in the iron sulphate as well as to prevent the oxidation of Fe²⁺ to Fe³⁺. The addition of carbon is also intended to increase the conductivity of the lithium iron phosphate active material in the cathode. Thus in particular EP 1 193 786 indicates that not less than 3 wt.-% carbon must be contained in the lithium iron phosphate carbon composite material in order to achieve the necessary capacity and corresponding cycle characteristics which are necessary for an electrode that functions well.

### SUMMARY

The object of the present invention was thus to provide electrodes containing lithium titanium spinel as active material with a higher specific load capacity (W/kg or W/I) and an increased specific energy density for rechargeable lithium-ion batteries.

According to the invention, this object is achieved by an electrode, free of added conductive agent, with a lithium titanate as active material.

It was unexpectedly found that the addition of conductive agents, such as carbon black, acetylene black, ketjen black, graphite, etc., to the formulation of an electrode according to the invention can be dispensed with, without its operability being adversely affected. This was all the more surprising because, as stated above, the lithium titanium spinels are typically insulators.

However, the term “free of added conductive agent” here also includes the possible presence of small quantities of carbon in the formulation, e.g. through a carbon-containing coating or in the form of a lithium titanate carbon composite material or also as powder e.g. in the form of graphite, carbon black, etc., but these do not exceed a proportion of at most 1.5 wt.-%, preferably at most 1 wt.-%, still more preferably at most 0.5 wt.-%.

By “lithium titanate carbon composite material” is meant here that carbon is evenly distributed in the lithium titanate and forms a matrix, i.e. the carbon particles can form in situ e.g. as nucleation sites for lithium titanate during synthesis. The term “carbon-containing composite material” is defined e.g. in EP 1 391 424 A1 and EP 1 094 532 A1 to which full reference is made here.

Here, the term “lithium titanate” (or “lithium titanium spinel”) includes all lithium titanium spinels of the Li₁₊ₓTi₂₋ₓO₄ type with 0≦x ≦⅓ of the space group Fd3m and generally also any mixed lithium titanium oxides of the generic formula LiₓTi_{y}O (0<y, y<1).

By “a lithium titanate” is meant a doped or non-doped lithium titanate within the meaning of the above definition.

Quite particularly preferably, the lithium titanate used according to the invention is phase-pure. By “phase-pure” or “phase-pure lithium titanate” is meant according to the invention that no rutile phase can be detected in the end-product by means of XRD measurements within the limits of the usual measurement accuracy. In other words, the lithium titanate according to the invention is rutile-free in this preferred embodiment.

In preferred developments of the invention, the lithium titanate according to the invention is, as already stated, doped with at least one further metal, which leads to a further increase in stability and cycle stability when the doped lithium titanate is used as anode. In particular, this is achieved by incorporating additional metal ions, preferably Al, Mg, Ga, Fe, Co, Sc, Y, Mn, Ni, Cr, V or several of these ions, into the lattice structure. Aluminium is quite particularly preferred. The doped lithium titanium spinels are also rutile-free in particularly preferred embodiments.

The doping metal ions which can sit on lattice sites of either the titanium or the lithium are preferably present in a quantity of from 0.05 to 10 wt.-%, preferably 1-3 wt.-%, relative to the total spinel.

The electrode preferably has a proportion of active material of ≧94 wt.-%, still more preferably of 96 wt.-%. Even with these high levels of active matter in the electrode according to the invention, its operability is not restricted.

It was surprisingly found in the present case that a polymodal primary particle-size distribution of the active material, i.e. of the lithium titanate, leads to an improved material density and increased capacity density of an electrode according to the invention compared with substantially monomodal particle-size distributions of the active material regardless of the respective particle size of the active material. Thus, because of the polymodal particle-size distribution, the tap density of the active material according to the invention is also more than 10% higher than with a purely monomodal distribution.

### DETAILED DESCRIPTION

The German terms “Partikel” and “Teilchen” here are used synonymously to mean particle.

By “primary particles” are meant all particles that can be distinguished visually in scanning electron microscope photographs which have a point resolution of 2 nm. The primary particles can also be present in the form of agglomerates (secondary particles).

The active material of the electrode according to the invention is preferably a mixture of lithium titanates with different primary particle-size distributions which can be obtained for example by different synthesis routes of the lithium titanate charges used for the mixture. It is preferred in this case that each lithium titanate has a (different) monomodal particle-size distribution.

Quite particularly preferably, the primary particle-size distribution of the active material is bimodal, as here the best values are achieved in respect of material density and capacity density of the electrodes according to the invention. This is, as stated, preferably set by a mixture of two lithium titanates with different monomodal particle-size distribution. The tap density of such a material is e.g. more than 0.7 g/cm³.

The first maximum of the primary particle-size distribution is advantageously a primary particle size of 100-300 nm (fine-particle lithium titanate), preferably 100-200 nm, and the second maximum is a primary particle size of 2-3 μm (d₅₀=2.3+0.2 μm, coarse-particle lithium titanate).

Quite particularly good values of the two previously mentioned electrode parameters are achieved if 15 to 40%, preferably 20 to 30% and quite particularly preferably 25% ±1%, of all primary particles have a primary particle size of 1-2 μm.

In advantageous developments of the present invention, some or all primary particles of the active material have a carbon coating. This is applied e.g. as described in EP 1 049 182 B1 or DE 10 2008 050 692.3. Further coating methods are known to a person skilled in the art. The proportion of carbon in the whole electrode is, in this specific embodiment, <1.5 wt.-%, preferably ≧1 wt.-% and most preferably 0.5 wt.-%, thus clearly below the value named in the state of the art cited above and previously considered necessary.

The electrode according to the invention advantageously has an electrode density of ≧2 g/cm³, more preferably ≧2.2 g/cm³. This leads to an increased capacity density of ≧340 mAh/cm³ at C/20 of the electrodes according to the invention compared with electrodes containing a lithium titanate and added conductive agent such as are known from the state of the art and which have a capacity density of only from 200 to 250 mAh/cm³.

The electrode according to the invention further contains a binder. Any binder known per se to a person skilled in the art may be used as binder, such as for example polytetrafluoroethylene (PTFE), polyvinylidene difluoride (PVDF), polyvinylidene difluoride hexafluoropropylene copolymers (PVDF-HFP), ethylene-propylene-diene terpolymers (EPDM), tetrafluoroethylene hexafluoropropylene copolymers, polyethylene oxides (PEO), polyacrylonitriles (PAN), polymethyl methacrylates (PMMA), carboxymethylcelluloses (CMC), and derivatives and mixtures thereof.

The present invention further relates to a secondary lithium-ion battery the anode of which is an electrode according to the invention. In this embodiment, the cathode can be freely chosen and typically contains one of the known lithium compounds such as lithium manganese spinel, lithium cobalt oxide or a lithium metal phosphate such as lithium iron phosphate, lithium cobalt phosphate, etc., with and without added conductive agent.

Quite particularly preferably, the active material of the cathode is a doped or non-doped lithium metal phosphate with ordered or modified olivine structure or NASICON structure in a cathode formulation without added conductive agent.

By non-doped is meant that pure, in particular phase-pure, lithium metal phosphate is used. The term “phase-pure” is also understood in the case of lithium metal phosphates as defined above.

The lithium transition metal phosphate is preferably represented by the formula

LiₓN_{y}M_{1-31 y}PO₄

wherein N is a metal selected from the group Mg, Zn, Cu, Ti, Zr, Al, Ga, V, Sn, B, Nb, Ca or mixtures thereof;

M is a metal selected from the group Fe, Mn, Co, Ni, Cr, Cu, Ti, Ru or mixtures thereof;

and with 0<x≦1 and 0≦y<1.

The metal M is preferably selected from the group consisting of Fe, Co, Mn or Ni, thus, where y=0, has the formulae LiFePO₄, LiCoPO₄, LiMnPO₄ or LiNiPO₄. LiFePO₄ and LiMnPO₄ are quite particularly preferred.

By a doped lithium transition metal phosphate is meant a compound of the above-named formula in which y=0 and N represents a metal cation from the group as defined above.

Quite particularly preferably, N is selected from the group consisting of Nb, Ti, Zr, B, Mg, Ca, Zn or combinations thereof, but preferably represents Ti, B, Mg, Zn and Nb. Typical preferred compounds are e.g. LiNb_{y}FeₓPO₄, LiMg_{y}FeₓPO₄, LiMg_{y}FeₓMn_{1-x-y}PO₄, LiZn_{y}FeₓMn_{1-x-y}PO₄, LiFeₓMn₁₋ₓPO₄, LiMg_{y}FeₓMn_{1-x-y}PO₄ with x and y <1 and x+y <1.

The doped or non-doped lithium metal phosphate, as already stated above, thus quite particularly preferably has either an ordered or a modified olivine structure.

Lithium metal phosphates in ordered olivine structure can be described structurally in the rhombic space group Pnma (No. 62 of the International Tables), wherein the crystallographic index of the rhombic unit cells may here be chosen such that the a-axis is the longest axis and the c-axis is the shortest axis of the unit cell Pnma, with the result that the mirror plane m of the olivine structure comes to lie perpendicular to the b-axis. The lithium ions of the lithium metal phosphate then arrange themselves in olivine structure parallel to the crystal axis [010] or perpendicular to the crystal face {010}, which is thus also the preferred direction for the one-dimensional lithium-ion conduction.

By modified olivine structure is meant that a modification takes place at either the anionic (e.g. phosphate by vanadate) and/or cationic sites in the crystal lattice, wherein the substitution takes place through aliovalent or identical charge carriers in order to make possible a better diffusion of the lithium ions and an improved electronic conductivity.

In further preferred embodiments of the present invention, the cathode formulation further contains a second lithium-metal-oxygen compound, different from the first, selected from doped or non-doped lithium metal oxides, lithium metal phosphates, lithium metal vanadates and mixtures thereof. Naturally, it is also possible that two, three or even more further, different lithium-metal-oxygen compounds are included.

The second lithium-metal-oxygen compound is preferably selected from doped or non-doped lithium manganese oxide, lithium cobalt oxide, lithium iron manganese phosphate, lithium manganese phosphate, lithium cobalt phosphate.

The present invention is described in more detail below with reference to the embodiment examples as well as the figures which are not, however, to be considered limiting.

### BRIEF DESCRIPTION OF THE DRAWINGS

FIG. 1 the dependency of the electrode density on the electrode formulation of electrodes of the state of the art

FIG. 2 the dependency of the electrode density on the electrode formulation of electrodes according to the present invention

FIG. 3 the capacity density of electrodes of the state of the art during discharge

FIG. 4 the capacity density of electrodes according to the invention during discharge

### EMBODIMENT EXAMPLES

Coarse-particle lithium titanate (particle size 1-3 μm, abbreviation: LiTi) without and with carbon coating is commercially available from Süd-Chemie AG, Germany, under the name EXM1037 and EXM1948 respectively. Fine-particle lithium titanate (particle size 100-200 nm) without and with carbon coating was produced according to the instructions in DE 10 2008 050 692.

The particle-size distribution was determined according to DIN 66133 by means of laser granulometry with a Malvern Mastersizer 2000.

The “tap density” is determined by means of a STAV II jolting volumeter from J. Engelmann AG. For this, approx. 100 ml powder was weighed under dry nitrogen in a measuring cylinder, attached to the jolting volumeter and then subjected to 3000 jolts. The volume is then read out and the tap density determined from it.

1. Production of Electrodes

1.1 Electrode Formulation of the State of the Art

A standard electrode of the state of the art contained 85% active material, 10% Super P carbon black (Timcal SA, Switzerland) as added conductive agent and 5 wt.-% polyvinylidene fluoride as binder (Solvay 21216).

1.2 Electrode Formulation According to the Invention

The standard electrode formulation for the electrode according to the invention was 95% active material and 5% PVdF binder. The active material consisted of a mixture of coarse-particle lithium titanate (EXM 1037, LiTi for short) and fine-particle lithium titanate (according to DE 10 2008 050 692) in respectively varying proportions.

1.3 Electrode Production

The active material was mixed, together with the binder (or, for the electrodes of the state of the art, with the added conductive agent), in N-methylpyrrolidone, applied to a pretreated (primer) aluminium foil by means of a coating knife and the N-methylpyrrolidone was evaporated at 105° C. under vacuum. The electrodes were then cut out (13 mm diameter) and compressed in an IR press with a pressure of 5 tons (3.9 tons/cm³) for 20 seconds at room temperature. The primer on the aluminium foil consisted of a light carbon coating, which improves the electric contact on the aluminium foil and the adhesion of the active material.

The electrodes were then dried overnight at 120° C. under vacuum and assembled and electrochemically measured against lithium metal in half cells in an argon-filled glovebox.

The electrochemical measurements were carried out using LP30 (Merck, Darmstadt) as electrolyte (ethylene carbonate (EC):dimethyl carbonate (DMC)=1:1, 1 MLiPF₆). The test procedure was carried out in the CCCV mode, i.e. cycles with a constant current at the C/10 rate for the first, and at the C rate for the subsequent, cycles. A constant voltage portion followed at the voltage limits (1.0 and 2.0 volt versus Li/Li⁺) until the current fell approximately to the C/50 rate, in order to complete the charge/discharge cycle.

The results of the electrode measurements were as follows and are plotted in the figures:

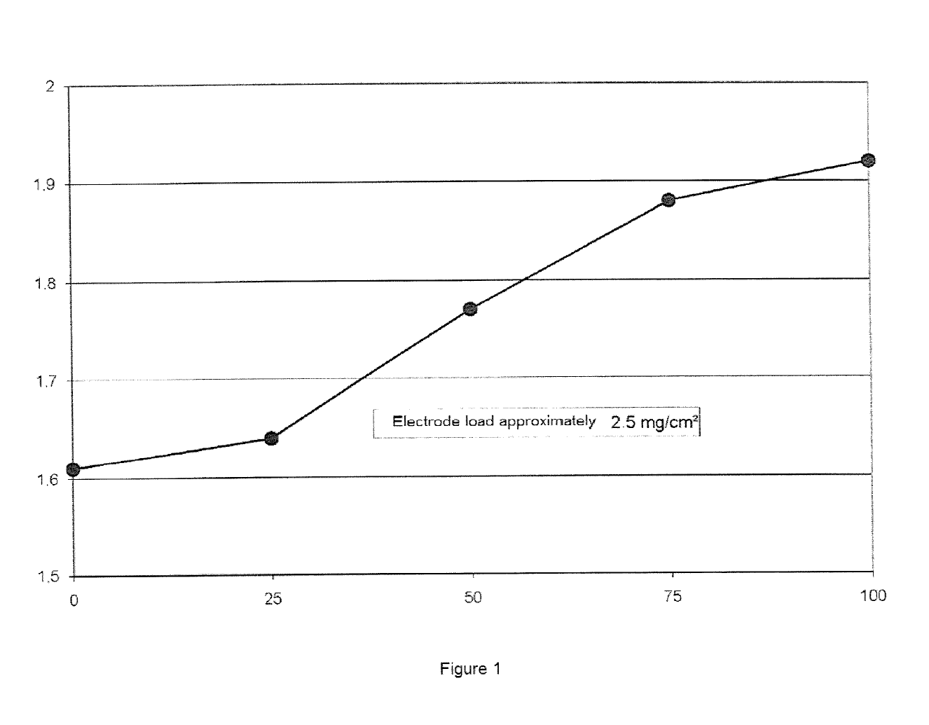

FIG. 1 shows the electrode density as a function of the electrode composition (formulation) of electrodes of the state of the art with 10% added conductive agent, which have a practically linear dependency of the electrode density (g/cm³) on the composition of the electrode. The ordinate shows the variation of the proportions by weight of lithium titanate 1 (LiTi) in the mixture of lithium titanate 1 and 2. The linearity of the curve can probably be attributed to the fact that the added conductive agent, because of its very small particles, more quickly fills the spaces between the large lithium titanate particles of the LiTi. However, the very small particles of the added conductive agent also entail a high porosity and thus a low electrode density.

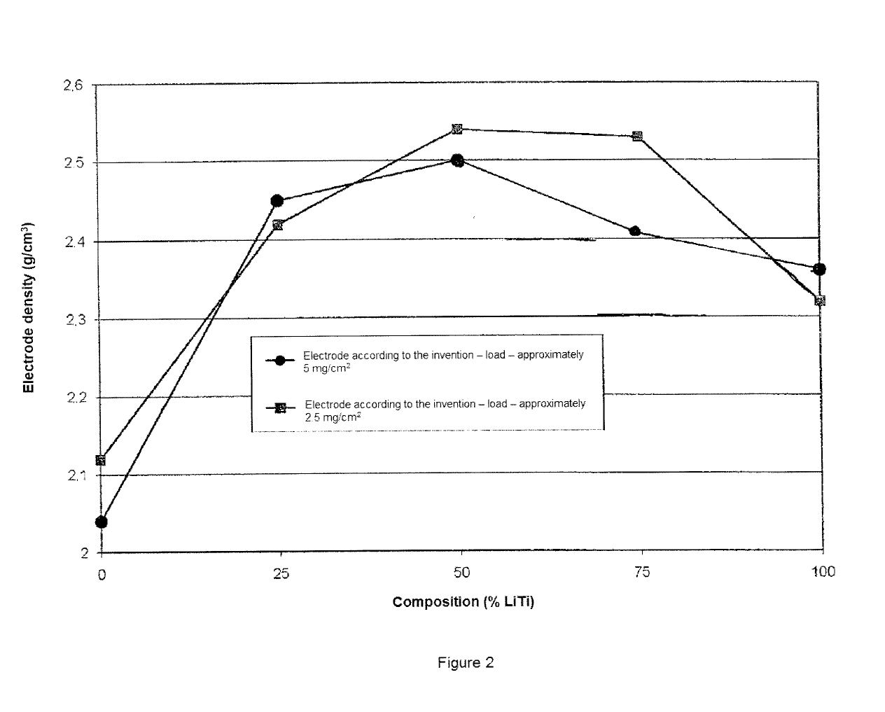

In contrast, FIG. 2 shows a non-linear progression of the electrode density relative to the composition of the electrode formulation. Here too, the ordinate shows the variation of the proportions by weight of lithium titanate 1 (LiTi) in the mixture of lithium titanate 1 and 2. As can be seen from FIG. 2, the electrode density of electrodes according to the invention which have a bimodal (primary) particle-size distribution is higher than in the case of respectively monomodal distribution of electrodes which contain only LiTi or lithium titanate 2. The best results are achieved for a proportion of LiTi in the active matter in a range of from 25 to 75 for loads of approximately 5 mg/cm² and for lower loads (2.5 mg/cm²). This can be attributed to the fact that the small agglomerates of the fine-particle lithium titanate fill the spaces between the particles of the more coarse-grained lithium titanate better, whereupon the total density of the electrode is increased. The increased electrode density also leads to an increase in the specific capacity density in particular during the discharge process.

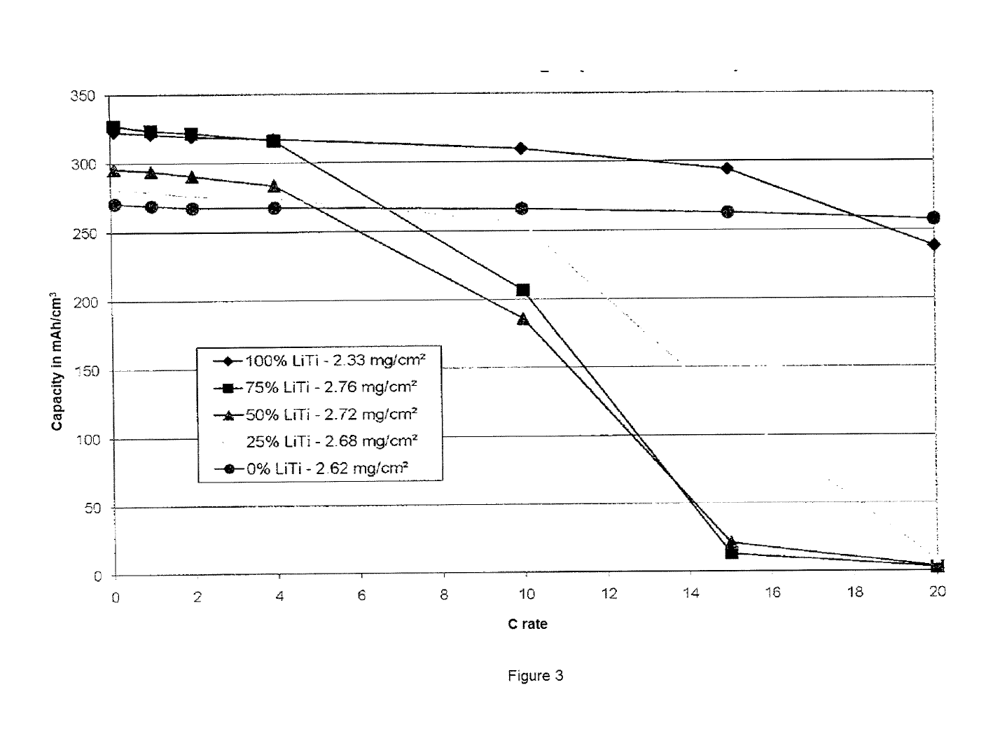

FIG. 3 shows the progression of the capacity density in relation to the proportion of LiTi in an electrode formulation of the state of the art with 10% added conductive agent. The best values are achieved here for the formulations which contained respectively either only coarse-particle lithium titanate or fine-particle lithium titanate as active matter.

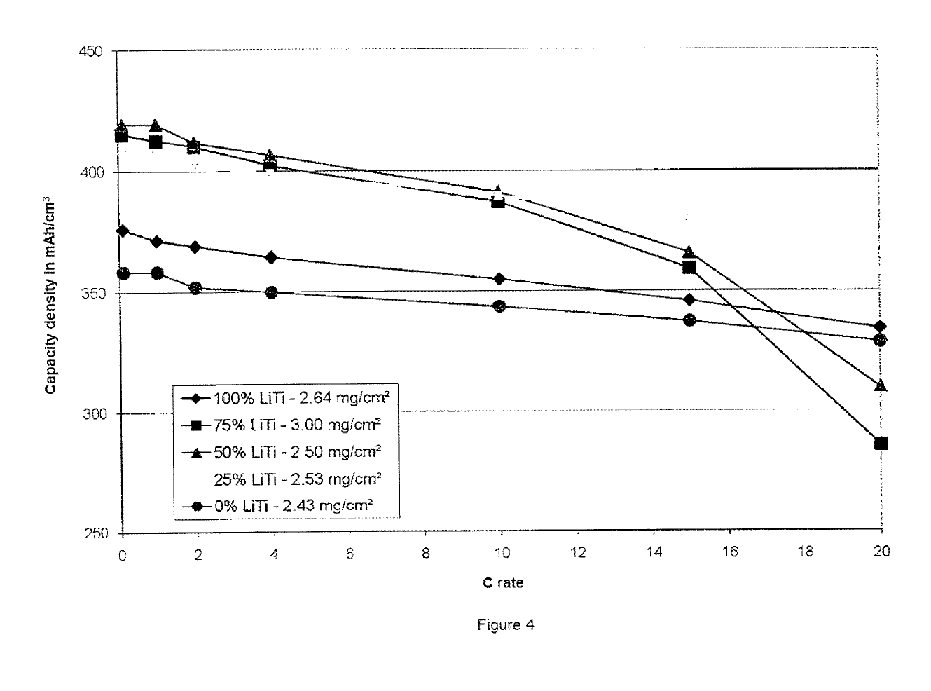

In contrast, FIG. 4 shows that a bimodal particle-size distribution with a proportion of 25% coarse-particle lithium titanate (LiTi) in the active matter produces the best results in electrodes according to the invention. An added advantage is the fact that the electrodes according to the invention show barely an increase in polarization. Not only is an increased specific capacity density obtained thereby, but also an increased specific energy density.

1. Electrode, free of added conductive agent, with a lithium titanate as active material.

2. Electrode according to claim 1 with a proportion of the active material of 94 wt.-%.

3. Electrode according to claim 2, in which the active material has a polymodal primary particle-size distribution.

4. Electrode according to claim 3, wherein the active material is a mixture of lithium titanates with different primary particle-size distributions.

5. Electrode according to claim 3, wherein the primary particle-size distribution of the active material is bimodal.

6. Electrode according to claim 5, wherein the first maximum of the primary particle-size distribution is a primary particle size of 100-300 nm and the second maximum is a primary particle size of 2-3 μm.

7. Electrode according to claim 5, wherein 15 to 40 percent of all primary particles have a primary particle size of 2-3 μm.

8. Electrode according to claim 1, in which some or all primary particles of the active material have a carbon coating.

9. Electrode according to claim 1 with an electrode density of ≧2 g/cm³.

10. Electrode according to claim 9 with a capacity density of ≧340 mAh/cm³ at C/20.

11. Secondary lithium-ion battery the anode of which is an electrode according to claim 1.

12. Secondary lithium-ion battery according to claim 11 the cathode of which contains a doped and/or non-doped lithium metal phosphate as active material.

13. Secondary lithium-ion battery according to claim 12, wherein the lithium metal phosphate is a doped or non-doped lithium iron phosphate.
